(19) United States
(12) Patent Application Publication
(10) Pub. No.: US 2002/0145698 A1
(43) Pub. Date: Oct. 10, 2002

(54) Liquid crystal display apparatus and method for producing same

(76) Inventors: Masato Imai, Gifu (JP); Kazuyuki Endo, Gifu (JP); Toshihisa Uchida, Gifu (JP)

Correspondence Address: Sonnenschein, Nath & Rosenthal, P.O. Box #061080, Wacker Drive Station - Sears Tower, Chicago, IL, 60606, US

(21) Appl. No.: 09/894,566

(22) Filed: Jun. 28, 2001

(30) Foreign Application Priority Data
Jun. 30, 2000 (JP) P2000-197622

(51) Int. Cl. G02F 1/1339

(52) U.S. Cl. 349/156

(57) ABSTRACT

A liquid crystal display device can be improved in orientation by exploiting axially symmetrical orientation. The liquid crystal display device includes a pair of substrates arranged facing each other with a pre-set gap in-between, liquid crystals held in the gap, a unit for applying an electrical field to the liquid crystals to change its state of orientation, a wall structure formed in each of small-sized areas obtained on sub-division along at least one substrate for orienting the liquid crystals lying in each small-sized area axially symmetrically on application of the electrical field, and a groove structure formed in each of the small-sized areas and adapted for adjusting the axial symmetrical orientation of the liquid crystals in cooperation with the wall structure.

### RELATED APPLICATION DATA

The present invention claims priority to Japanese Application No. P2000-197622 filed May Jun. 30, 2000, which application is incorporated herein by reference to the extent permitted by law.

### BACKGROUND OF THE INVENTION

1. Field of the Invention

This invention relates to a liquid crystal display device and a method for the preparation thereof. More particularly, it relates to a improvement in an axial symmetry orientation technique aimed at widening the angle of view of a liquid crystal display device.

2. Description of Prior Art

Because of the simple manufacturing process and good display characteristics from the front side, a liquid crystal display device employing the twisted nematic (TN) mode is currently the mainstream of the flat display. The TN mode liquid crystal however suffers from narrow angle of view characteristics which are problematical especially in application to a large format television screen. A variety of methods have so far been proposed as means to overcome this deficiency. The current mainstream is providing a liquid crystal display device of the TN mode with an optical compensation film for widening the angle of field of view. However, the improving effect is not sufficient, while the optical compensation film cannot be enlarged with ease in view of uniformity of characteristics.

There is also known a method of splitting individual pixels, formed in the liquid crystal display device, into plural areas, and of controlling the state of orientation from one split area to another (pixel splitting method), and a variety of techniques for realizing the method, have been devised. Among other known methods, there are also known a method of forming a fine mask in each pixel by photolithography to form plural areas with different rubbing (orientation) directions and a method of locally controlling the direction of orientation using polarizing UV rays. However, these methods suffer from substrate contamination during the process and from the lowering in reliability ascribable to materials and hence are not put to practical use.

There are also proposed techniques for widening the field of view using liquid crystal modes other than the TN mode. For example, an IPS mode, as disclosed in Japanese Patent Publication H1-120528, and an MVA mode (Japanese Laying-Open Publication H-11-242225), have been devised. The IPS mode uses an electrical field parallel to a substrate surface to control the orientation of the liquid crystal to achieve a wide angle of field of view. However, because of its peculiar operating principle, significant limitations are imposed on the electrode structure to raise the problem of the lowering of the aperture ratio and the response speed. The MVA mode forms a protuberant structure on each surface of each of a pair of substrates by photolithography to control the state of liquid crystal orientation to achieve the wide angle of field of view. However, since a protuberant structure is formed on each surface of each of the paired facing substrates, alignment accuracy is required of the two substrates during assembling. Moreover, the MVA mode cannot be applied to a panel structure in which it is difficult to perform lithographic processing on one of the paired substrates.

Apart from the above-mentioned techniques, an ASM mode (axially symmetric micro cell mode) has been proposed as powerful means for realization of a wide angle of field of view. The ASM mode has been disclosed in, for example, the Japanese Laying-Open Publication H-6-301015, Japanese Laying-Open Publication H-7-120728 and in Japanese Patent Application 2000-19522. In the ASM mode, the liquid crystal held by a pair of substrates is composed of a set of subdivided areas, with each liquid crystal area being controlled to axial symmetry in orientation. By the axial symmetry of the liquid crystal orientation, viewing angle dependency can be improved significantly. Specifically, liquid crystal molecules are multi-domain-oriented by a wall structure formed from area t area along one of the substrates to achieve a wide angle of field of view. In particular, in the ASM mode employing an n-type liquid crystal with negative dielectric anisotropy, a liquid crystal display device may be realized with a wide angle of field of view and a high contrast.

FIG. 1 shows a structure and an operating principle of a conventional liquid crystal display device exploiting the ASM mode. FIG. 1A shows a state with no voltage being applied. As shown, a liquid crystal 16 is held between a lower substrate 4 and an upper substrate 8. On the inner surfaces of the substrates 4, 8, are formed electrodes 10Z, 10 for applying an electrical field to the liquid crystal. A wall structure is formed on the inner surface of the upper substrate 8. This wall structure is formed for encircling a rectangular area 15. As shown, an initial orientation is produced between the wall surface of the wall structure 17 and a liquid crystal molecule 16M. Meanwhile, the paired substrates 4, 8 are joined together with interposition of a spacer 20 in-between.

FIG. 1B shows the state of applying an electrical field to the liquid crystal 16. In FIG. 1A, the liquid crystal molecule 16M, oriented substantially perpendicularly in the state devoid of voltage application, transfers to the horizontal orientation as a result of the electrical field application. The molecular orientation is determined at this time under the effect of the initial orientation between the liquid crystal molecule 16M and the wall surface of the wall structure 17 to realize the state of axially symmetrical orientation.

FIG. 1C is a plan view schematically showing the axially symmetrical orientation on voltage application. In the rectangular area 15, the liquid crystal molecule 16M is oriented axially symmetrically, with an axis perpendicular to a point of intersection of both diagonal lines as center. Basically, the liquid crystal molecule 16M is oriented towards the four sides of the area 15, however, in hatched areas, the liquid crystal molecules are oriented towards each apex point of the rectangular area 15.

The orientation obtained in the conventional ASM mode is the multi-domain orientation shown in FIG. 1C, and may pseudonymously be deemed to be of 8-domain orientation. If a liquid crystal panel is introduced into a space between two polarizing plates, having axis of polarization extending at right angles to each other, in order to make display as a liquid crystal display, the light utilization efficiency is lowered significantly in a domain where the axis of polarization is not perpendicular nor parallel to the direction of orientation (hatched area), with the result that an extinguished light pattern termed an arrow wheel pattern is produced. The result is that, if the driving voltage/transmittance characteristics are measured, it may be seen that the transmittance is lower than in the case of uniform orientation to lower the steepness of the driving voltage/transmittance characteristics. Moreover, since the element controlling the state of orientation is the wall surface of the wall structure, the orientation controlling force is weaker at a mid portion of the area of orientation 15 to produce disturbed state of orientation and lowered response speed. In order to prevent this from occurring, a minor quantity of the photo-polymerizable resin is added to the liquid crystal to make for the shortage of the orientation controlling force. However, the complicated process and the lowering of reliability due to addition of the additive pose a problem. In addition, the residual image tends to be produced depending on the photo-polymerizable material used or on process conditions.

### SUMMARY OF THE INVENTION

It is therefore an object of the present invention to improve the orientation of the liquid crystal display device exploiting axial symmetrical orientation.

The present invention provides liquid crystal display device including a pair of substrates arranged facing each other with a pre-set gap in-between, liquid crystals held in the gap, means for applying an electrical field to the liquid crystals to change the state of orientation thereof, a wall structure formed in each of small-sized areas obtained on sub-division along at least one substrate for orienting the liquid crystals lying in each small-sized area axially symmetrically on application of the electrical field and a groove structure formed in each of the small-sized areas and adapted for adjusting the axial symmetrical orientation of the liquid crystals in cooperation with the wall structure.

Preferably, the wall structure is formed for encircling a rectangular area and the groove structure is formed for extending along diagonal lines of the rectangular area. The liquid crystals in each small-sized area are divided into four groups and are oriented symmetrically with respect to an axis perpendicular to a point of intersection of the two diagonals lines. The one substrate is a transparent plate and a color filter layer, a transparent insulating layer and a transparent electrically conductive layer are formed on one surface thereof. The groove structure is formed by patterning at least one of the color filter layer, transparent insulating layer and the transparent electrically conductive layer by etching, photo-lithography or grinding. The one substrate includes an electrode as means for applying an electronic field to the liquid crystals. The groove structure is formed in an insulating layer formed in the electrode itself or in an insulating film arranged on a reverse surface or a front surface of the electrode. The liquid crystals are of negative dielectric constant anisotropy and the surfaces of the two substrates are processed for orienting the liquid crystals perpendicularly, that is homeotropically, in the absence of applied voltage. If necessary, a photo-polymerizable resin is added to the liquid crystals for stabilizing the state of axially symmetrical orientation produced on application of an electrical field. In a preferred embodiment, the axially symmetrical orientation of the liquid crystals are distorted along the axis and display is by exploiting optical rotating characteristics. In this case, a chiral substance is added to the liquid crystals for distorting the state of orientation thereof. In another preferred embodiment, the axially symmetrical orientation of the liquid crystals is not distorted along the axis and display is made by exploiting birefringence. Specifically, display is made while homeotroic orientation is switched to homogeneous orientation and vice versa. In another preferred embodiment, the means for applying the electrical field is signal electrodes formed in columns on one substrate and discharge channels formed in rows on the other substrate, the discharge channel being separated from the liquid crystals by a dielectric sheet. Alternatively, facing electrodes may be formed on the two substrates, such as active matrix type or simple matrix type display device.

According to the present invention, the groove structure is provided in addition to the wall structure serving for axially symmetrically orienting the liquid crystals contained in each small-sized area, with the groove structure serving for adjusting axially symmetrical orientation of liquid crystals in cooperation with the wall structure. For example, by providing the groove structure on two diagonal lines of the rectangular wall structure, four-domain orientation resulting from division into four by two diagonal lines may be realized in place of the eight-domain orientation in a shape of an arrow wheel. In each domain, liquid crystals are oriented parallel or perpendicularly to the axis of polarization of a polarization plate, so that there is no loss of transmittance, while the applied voltage/transmittance characteristics may be steeper than is possible with the prior art.

According to the present invention perfect four-domain orientation may be achieved by forming a grooved structure in addition to the wall structure to enable boarder angle of view characteristics than is possible with the conventional pseudonymous eight-domain orientation. Moreover, since extinct areas in the shape of an arrow wheel pattern may be eliminated, the light utilization efficiency may be improved to raise the transmittance. In addition, the transmittance/driving voltage characteristics may be steeper to enable the liquid crystal to be driven at a lower voltage. Moreover, crosstalk may be reduced by lowering the driving voltage. Since orientation controlling elements in the form of the groove structure may be provided at a mid portion of the rectangular area of orientation, the orientation controlling force is improved so that supplementary orientation processing of the photo-polymerizable resin is unnecessary. If the area of orientation is enlarged to realize one-for-one correspondence with the pixels of the liquid crystal display device, stable orientation may be achieved. In addition, the response speed may be improved because orientation eddying, produced conventionally, is not produced.

### BRIEF DESCRIPTION OF THE DRAWINGS

FIGS. 1A to 1C show a typical conventional liquid crystal display device.

FIG. 2 is a schematic view showing the basic structure of a liquid crystal display device embodying the present invention.

FIGS. 3A to 3C are a cross-sectional view and a plan view showing the basic structure of a plasma addressed liquid crystal display device.

FIG. 4 is a schematic view for illustrating the operation of the plasma addressed liquid crystal display device.

FIGS. 5A to 5I show respective steps of the process for the preparation of the plasma addressed liquid crystal display device.

FIG. 6 is a schematic view for illustrating the operation of the plasma addressed liquid crystal display device.

FIG. 7 is a schematic view for illustrating the operation of the plasma addressed liquid crystal display device.

FIGS. 8A and 8C are cross-sectional views of an embodiment of the plasma addressed liquid crystal display device and FIG. 8B is a plan view thereof.

FIG. 9 is a flowchart for illustrating the manufacturing method of the embodiment of the plasma addressed liquid crystal display device.

FIG. 10 is an equivalent circuit diagram of the embodiment of the plasma addressed liquid crystal display device.

FIGS. 11A to 11C are schematic views showing a modeled orientation state of the plasma addressed liquid crystal display device.

FIG. 12 is a graph showing the transmittance/driving voltage characteristics of the liquid crystal display device.

FIGS. 13A and 13B are graphs showing angle of view characteristics of the liquid crystal display device.

FIG. 14 is a cross-sectional view showing a modeled liquid crystal display device.

FIG. 15 is an equivalent circuit diagram of the liquid crystal display device.

FIG. 16 is a graph showing the transmittance to input voltage ratio of the liquid crystal display device/groove depth characteristics.

FIG. 17 is a graph showing characteristics of the ratio of the voltage applied to a liquid crystal part of the liquid crystal display device/groove depth characteristics.

FIG. 18 is a cross-sectional view showing a modeled embodiment of a plasma addressed liquid crystal display device.

FIG. 19 is an equivalent circuit diagram of the liquid crystal display device.

FIG. 20 is a graph showing the equivalent transmittance to input voltage ratio/groove depth characteristics of the plasma addressed liquid crystal display device.

FIG. 21 is a graph showing characteristics of the ratio of the voltage applied to a liquid crystal part of the liquid crystal display device/groove depth characteristics.

FIG. 22 is a partial cross-sectional view showing a modification of liquid crystal display device.

FIG. 23 is a partial cross-sectional view showing a modification of the liquid crystal display device.

FIG. 24 is a partial cross-sectional view showing another modification of the liquid crystal display device.

FIG. 25 is a partial cross-sectional view showing a further modification of the liquid crystal display device.

FIG. 26 is a partial cross-sectional view showing a modification of a plasma addressed liquid crystal display device.

FIG. 27 is a partial cross-sectional view showing a further modification of the plasma addressed liquid crystal display device.

FIG. 28 is a partial cross-sectional view of another modification of the plasma addressed liquid crystal display device.

FIG. 29 is a plan view showing a modification of the liquid crystal display device.

FIG. 30 is a graph showing transmittance/driving voltage characteristics of a liquid crystal display device employing the ECB mode.

FIG. 31 is a schematic plan view showing a modification o the present invention.

FIG. 32 is a schematic plan view showing another modification o f the present invention.

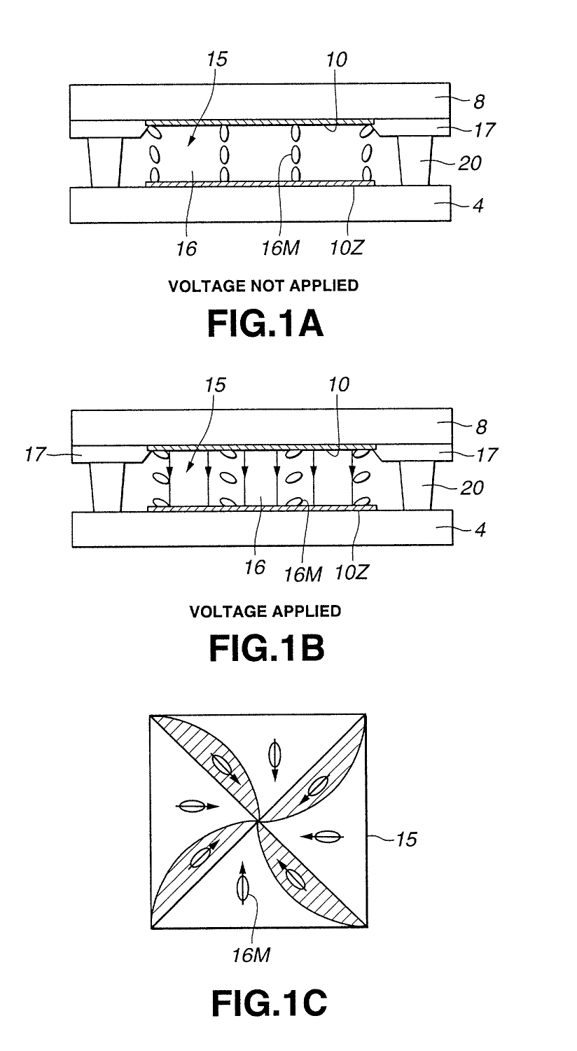

### DESCRIPTION OF THE PREFERRED EMBODIMENTS

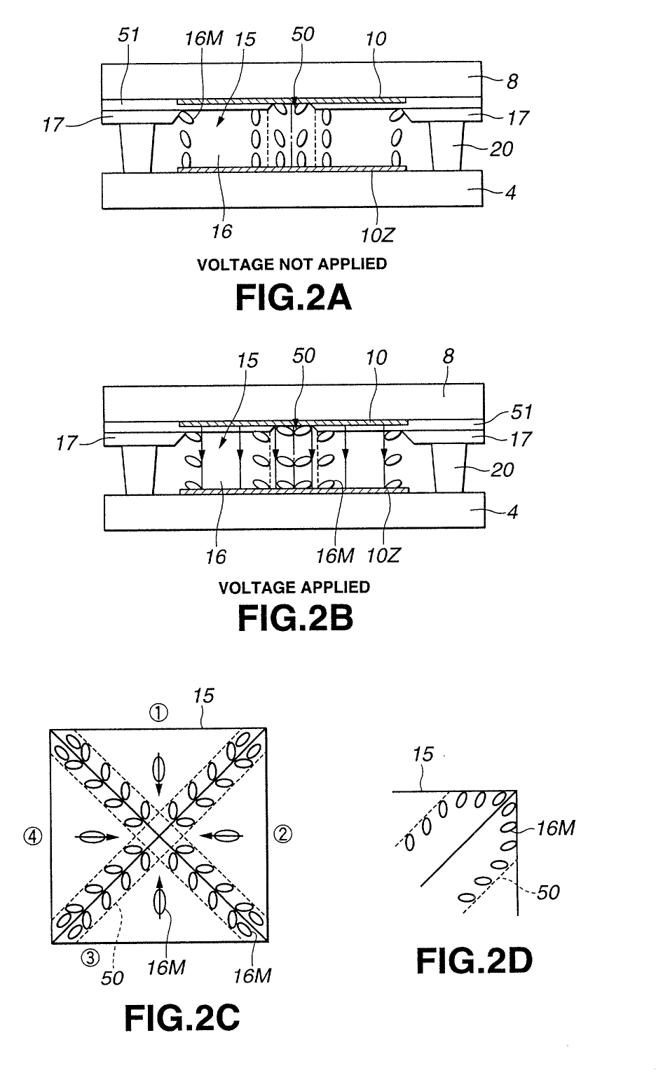

Referring to the drawings, preferred embodiments of according to the present invention will be explained in detail. FIG. 2 schematically shows a basic structure of a liquid crystal display device according to the present invention. FIGS. 2A and 2B show the state in which no voltage is applied and the state in which the voltage is applied, respectively. FIG. 2C shows the state of axially symmetrical orientation of liquid crystal molecules in the vicinity of a structure forming substrate when the voltage is applied and FIG. 2D schematically shows the state of orientation in the vicinity of a rectangular area of orientation. In the TN mode, a chiral substance is added in the TN mode to cause rotation of the orientation direction by 90° on the side counter substrate. As shown, the present liquid crystal display device includes a pair of substrates 4, 8 arranged facing each other at a pre-set interval in-between, a liquid crystal 16 held in the gap and means for applying an electrical field to the liquid crystal 16 to change the state of orientation. In the present embodiment, this electrical field applying means is made up of an electrode 10 formed on the inner surface of the upper substrate 8 and an electrode 10Z formed on the inner surface of the lower substrate 4. A wall section 17 is formed extending along the inner surface of the upper substrate 8 for encircling a small-sized area 15. If supplied with an electrical field, the wall section 17 orients the liquid crystal 16 contained in the area 15 axially symmetrically. In the present embodiment an insulating layer 51 is formed on the electrode 10 and the aforementioned wall section 17 is formed thereon. The wall section 17 is provided with a spacer 20 for prescribing the dimension of the gap between the substrates 4 and 8.

As characteristic of the present invention, a groove (grooved structure) 50 is formed in each area 15 and cooperates with the wall section 17 to adjust the axially symmetrical state of orientation of the liquid crystal 16. In the present embodiment the wall section 17 is formed in an insulating layer 51. In the present embodiment, the wall section 17 is formed for encircling the rectangular area 15, as shown in FIG. 2C. Moreover, the groove 50 is formed extending along a diagonal line of the rectangular area 15. In this case, the liquid crystal molecules 16M are subdivided into four portions along the intersecting two diagonal lines. The respective domains, thus divided, are indicated by \mathring{1}, \mathring{2}, \mathring{3} and \mathring{4}. The liquid crystal molecules are oriented symmetrically with respect to an axis perpendicular to a point of intersection of the two diagonal lines. That is, the liquid crystal molecules 16M are oriented in the vertical direction in the domains \mathring{1} and \mathring{3}, while being oriented in the horizontal directions in the domains \mathring{2} and \mathring{4}. Meanwhile, the direction of orientation of the liquid crystal molecules 16M is slightly deviated from the vertical or horizontal direction in the vicinity of the apex points of the rectangular area 15 to extend obliquely, as shown in FIG. 2D. However, the area of this deviation of the liquid crystal molecules 16M is limited to an extremely small area which may be discounted. Meanwhile, in the present embodiment, the dielectric constant has negative anisotropy, as shown in FIG. 2A. The surfaces of the substrates 4, 8 are orientation-processed at the outset, such that, if no electrical field is applied, the liquid crystal 16 is oriented perpendicularly.

According to the present invention, the liquid crystal molecules 16M are oriented perpendicularly to the substrate surface in the gap due to perpendicular orientation processing applied to the substrates 4, 8. At this time, the liquid crystal molecules 16M are oriented along the normal line direction relative to the wall surface of the wall section 17 and to the wall surface (usually an inclined surface) of the groove 50. In actuality, the liquid crystal molecules 16M are oriented in a stable direction which will minimize the energy with respect to the perpendicular force of orientation applied from the wall surface of the totality of structures, such as wall section 17 or the groove 50. Therefore, if the voltage is applied, four-domain orientation resulting from division along diagonal lines is realized, in place of the conventional multi-domain orientation including an arrow wheel pattern, pseudonymously an eight-domain orientation, as a result of provision of orientation assisting fine grooves along diagonal lines of the orientation area 15.

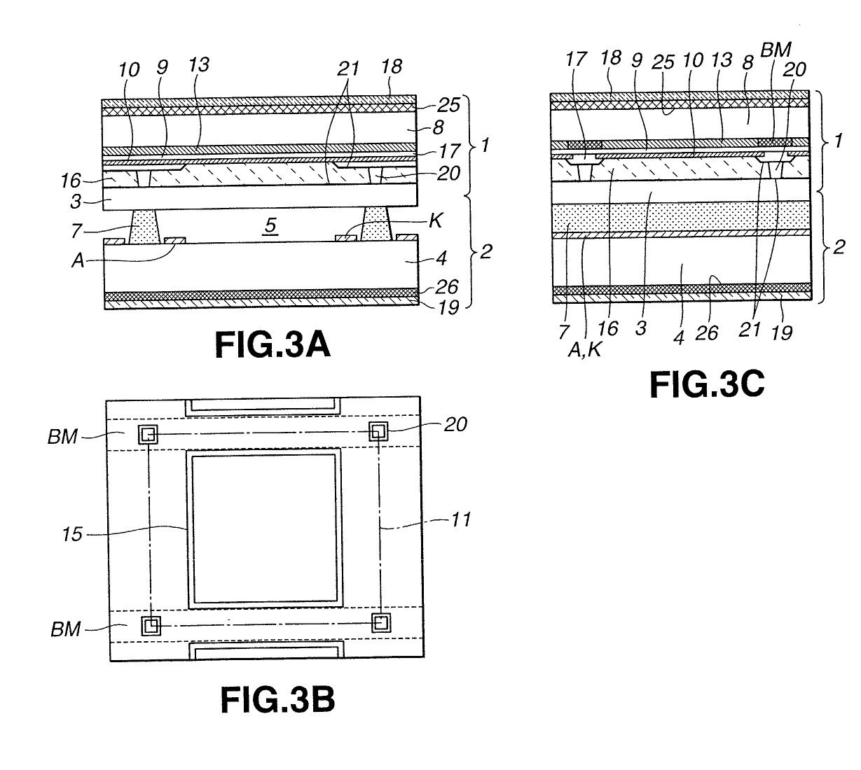

FIGS. 3a, 3b and 3c are a front view, a plan view and a side view of one pixel, respectively. The plasma addressed liquid crystal display device, as shown, has a flat panel structure comprised of a display cell 1 for modulating the incident light into outgoing light responsive to picture signals for displaying an image, and a plasma cell 2 surface-joined to the display cell 1 for scanning (addressing) the display cell 1. The plasma cell 2 includes a discharge channel 5 arrayed in the line direction and generates plasma discharge sequentially to scan the display cell 1 line-sequentially. The discharge channel 5 includes a pair of substrates 7, delimiting a space extending along a column and paired anode and cathode electrodes A and K arranged therein. On the outer surface of the plasma cell 2 are affixed a phase difference plate 26 and a polarization plate 19. The display cell 1 includes a signal electrode 10, arrayed along a column, and includes a pixel 11 at a point of intersection of the display cell 1 with the discharge channel 5. The display cell 1 applies a picture signal in synchronism with line sequential scanning to modulate the incident light from one pixel 11 to another.

The display cell 1 is separated from the plasma cell 2 by a dielectric sheet 3 formed by a glass sheet of an extremely thin thickness. The plasma cell 2 is constituted by a glass substrate 4 joined to the dielectric sheet 3 from below, whilst the above. In a gap between the substrate 8 and the dielectric sheet 3 is held a liquid crystal 16 as a display medium. The gap size is prescribed by the spacer 20. The liquid crystal 16 is sandwiched from above and below by oriented films 21 and is in a perpendicularly oriented state in the absence of an electrical voltage. The liquid crystal is comprised of a set of finely divided areas 15 of which only one area 15 is shown. The liquid crystal 16 contained in each area 15 is orientation controlled by the wall section 17 axially symmetrically. With the liquid crystal 16, oriented axially symmetrically, the angle of view characteristics can be improved significantly. With the liquid crystal 16, arranged axially symmetrically, the angle of view dependency may be improved appreciably. Since the retardation of the liquid crystal molecules, oriented axially symmetrically in the area 15, is compensated reciprocally, the transmittance of light rays from each angle of view direction is averaged to weaken the angle of view dependency. In the present embodiment, the state of axially symmetrical orientation is distorted along an axis perpendicular to the substrate. This light optical rotating properties are exploited to make a display. A color filter 13 is formed on the inner surface of the substrate 8, so that three prime colors of R, G and B are allocated to the respective pixels 11. The respective pixels are partitioned by a black mask BM. A planarizing film 9 formed of a transparent insulating material is interposed between the color filter 13 and the signal electrode 10.

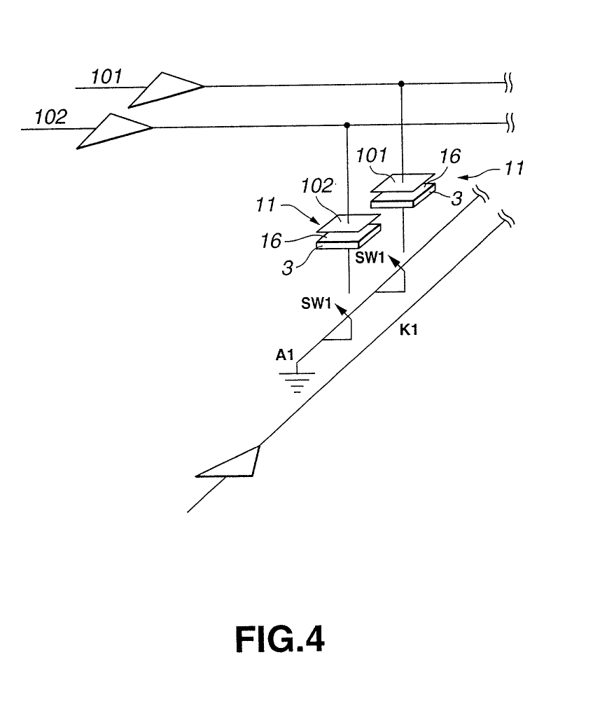

Only two pixels are shown in a schematic view of FIG. 4, in which only two signal electrodes 101, 102, a sole cathode electrode K1 and a sole anode electrode A1 are shown for facilitating the understanding. Each pixel 11 has a layered structure comprising signal electrodes 101, 102, a liquid crystal 16, a dielectric sheet 3 and a discharging channel. The discharging channel is connected during plasma discharge to substantially an anode potential during plasma discharge. If picture signals are applied in this state to the individual signal electrodes 101, 102, electrical charges are implanted to the liquid crystal 16 and to the dielectric sheet 3. When the plasma discharge comes to a close, the discharge channel reverts to an insulated state, so that a floating potential is set to hold implanted charges by each pixel by way of the so-called sample-and-hold operation. So, the discharge channel acts as an individual sampling switching device provided in each pixel and hence is schematically represented using a switching symbol SW1. On the other hand, the liquid crystal 16 and the dielectric sheet 3, held between the signal electrodes 101, 102 and the discharge channel, operate as sampling capacitors. If, when the sampling switch SW1 is turned on by line sequential scanning, the picture signals are held by the sampling capacitor so that the respective pixels are turned on or off responsive to the signal voltage level. The signal voltage is held by the sampling capacitor so that the active matrix operation of the display device occurs even after the sampling switch SW1 is turned off. In actuality, the effective voltage applied to the liquid crystal 16 is determined by capacitance division with the dielectric sheet 3.

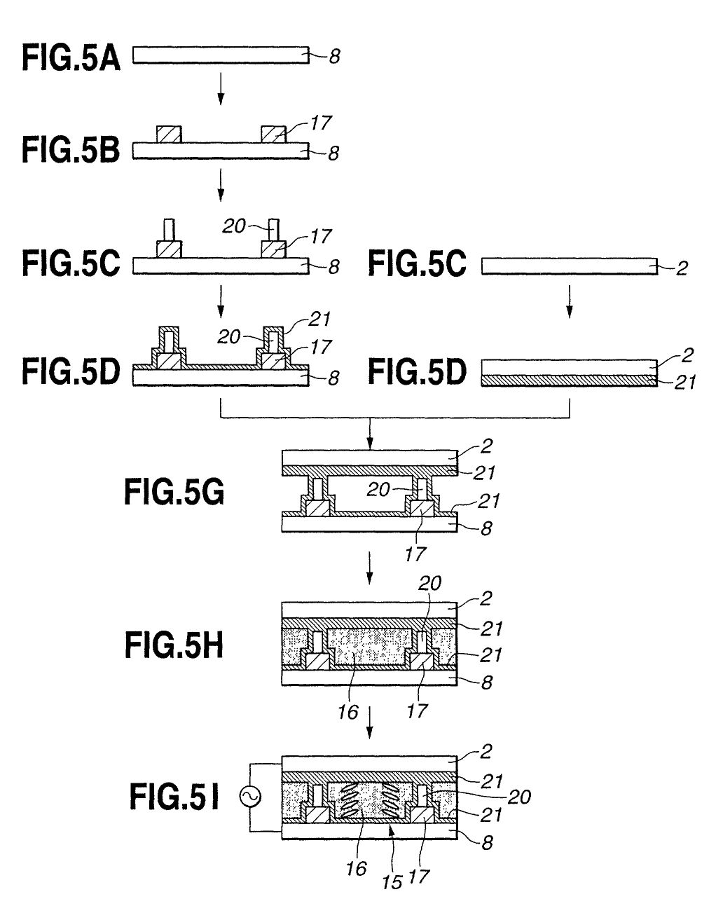

FIG. 5 shows a process diagram for the method for the preparation of a display cell. At step a, a color filter and a signal electrode are formed on one surface of the glass substrate 8. For facilitating the understanding, the glass substrate 8 is shown in a simplified form inclusive of the signal electrode and the color filter. At step b, the wall section 17 is formed as a lattice on the surface of the glass substrate 8. For example, the wall section 17 can be formed by applying a photosensitive resin and performing light exposure and development (photolithography) through a photomask having a lattice pattern. At a step c, a spacer 20 is discretely formed by patterning on the top of the wall section 17. For this step, a photolithographic technique can again be applied. At a step d, the surface of the glass substrate 8, carrying the wall section 17 and the spacer 20, is coated with a perpendicular orientation agent 21, such as polyimide. The plasma cell 2 is formed at a step e parallel to the above steps a to d. The plasma cell 2 includes a discharge channel between the glass substrate and the dielectric sheet. In FIG. 5, the plasma cell 2 is shown in a simplified form, with a dielectric sheet being arranged on its lower surface. At a step f, the perpendicular orientation agent 21 is applied at the outset on the surface of the dielectric sheet of the plasma cell 2.

At a step g, the plasma cell 2 and the glass substrate 8 are bonded together. The size of the gap therebetween can be controlled to a constant value by the wall section 17 and the spacer 20 over the entire screen surface. The inner surface of the display cell, so formed, is coated in its entirety with the perpendicular orientation agent 21. At a step h, the liquid crystal 16 is implanted by e.g., the vacuum implanting system into the inside of the display cell. In actuality, the liquid crystal 16 is a mixture comprised of an n-type liquid crystal material, chiral substance, monomers and a photo-initiator. Finally, at a step i, the liquid crystal area 15 is orientation controlled axially symmetrically. First, a pre-set AC voltage is applied to the liquid crystal 16 and the liquid crystal molecules are oriented axially symmetrically by taking advantage of the wall surface effect of the wall section 17. For finalizing the axially symmetrical oriented state, UV rays are illuminated using e.g., a high pressure mercury lamp. This photo-polymerizes the monomers to hold the axially symmetrically oriented state of the liquid crystal area 15 on memory.

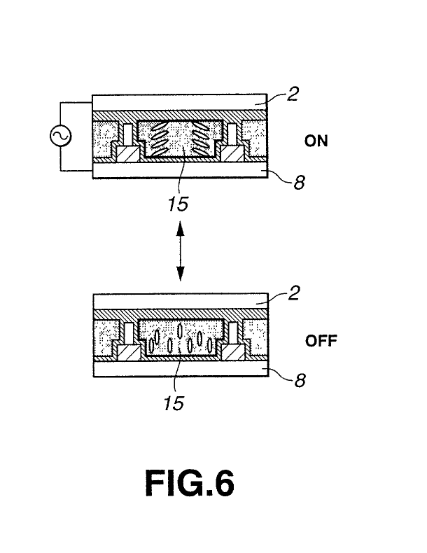

FIG. 6 schematically shows the operation of the display cell. In the on-state, with the voltage being applied, the liquid crystal area 15 is kept in its axially symmetrically oriented state. In the off state, with the voltage ceasing to be applied, liquid crystal molecules, contained in the liquid crystal area 15, transfers to the perpendicular orientation. The on-state can be reversibly switched to the off-state by turning the applied voltage on or off. Using e.g., a polarization plate, phase changes between the axial symmetrical orientation and the perpendicular orientation are taken out as changes in transmittance to make display.

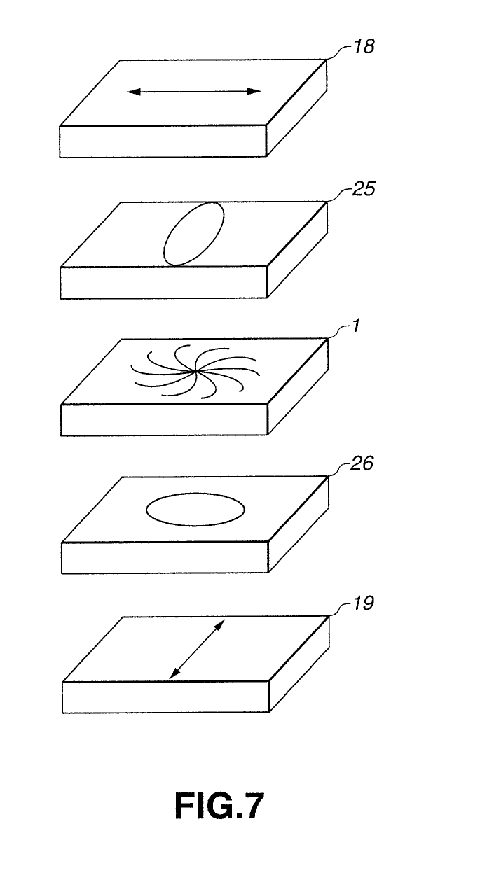

FIG. 7 schematically shows the optical function of the display cell 1 employing the axially symmetrically oriented mode. On the upper and lower surfaces of the display cell 1 are arranged polarization plates 18, 19, respectively. The axes of polarization of the polarization plates 18, 19 are denoted by arrows. These axes of polarization run at right angles to each other in a cross-nicol configuration. Meanwhile, a phase difference plate 25 is arranged between the display cell 1 and the polarization plate 18, whilst another phase difference plate 26 is arranged between the display cell 1 and the polarization plate 19. These phase difference plates 25, 26 are used for compensating the phase difference in case light falls from a direction inclined with respect to the liquid crystal molecules in the perpendicularly oriented state. As the phase difference plates 25, 26, use may be made e.g., of negative biaxial double refraction plates. In the illustrate state, the display cell 1 is in axially symmetrical orientation. However, the directors of the liquid crystal molecules are rotated 90° along the axial direction. The lineally polarized light, transmitting through the upper polarization plate 18, has its axis of polarization rotated by 90° by the display cell 1, and is transmitted in this state through the polarization plate 19 in the cross-nicol configuration to realize bright display. When the display cell 1 transfers from the axially symmetrically oriented state to the perpendicularly polarized state, the light optical rotating capability with respect to the lineally polarized light is lost. So, the linear polarized light, transmitted through the polarization plate 18, directly reaches the polarization plate 19. Since the linear polarized light is at right angles to the axis of polarization of the polarization plate 19, the incident light is interrupted. This realizes dark display.

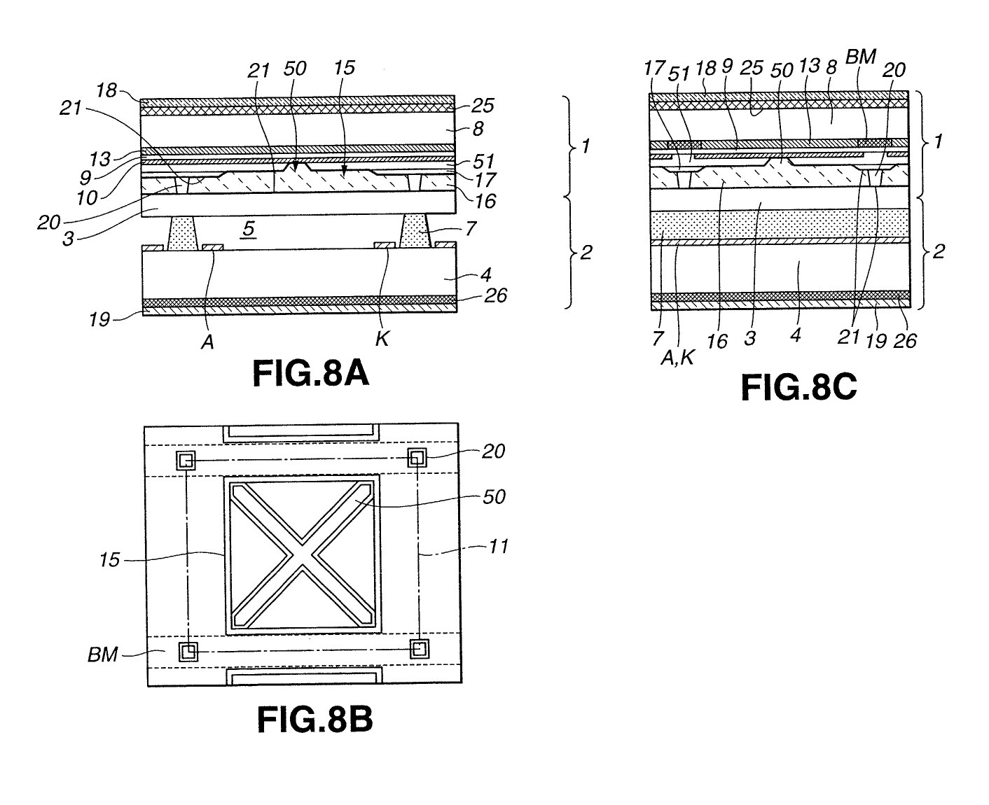

FIG. 8 schematically shows an embodiment of the present invention to a plasma addressed liquid-crystal display device. The plasma addressed liquid crystal display device of the present invention is made up of the display cell 1 and the plasma cell 2 bonded together by the dielectric sheet 3. The display cell 1 is made up of a CF substrate 8, having a transparent signal electrode 10 of, for example, ITO, or a color filter 13, and the liquid crystal 16 held between the CF substrate 8 and the dielectric sheet 3. As characteristic of the present plasma addressed liquid crystal display device, a groove 50 is formed in the area 15 surrounded by the rectangular wall section 17. This groove is formed by patterning an insulating film 51 formed on the signal electrode 10. Specifically, the insulating film 51 is formed by photolithography, etching or grinding. On the other hand, the plasma cell 2 is formed by exploiting the lower glass substrate 4. A hermetically sealed discharge channel 5 is formed between it and the dielectric sheet 3. In the present specification, the plasma cell 2 is sometimes represented by a plasma (PL) substrate 4 which serves as its foundation.

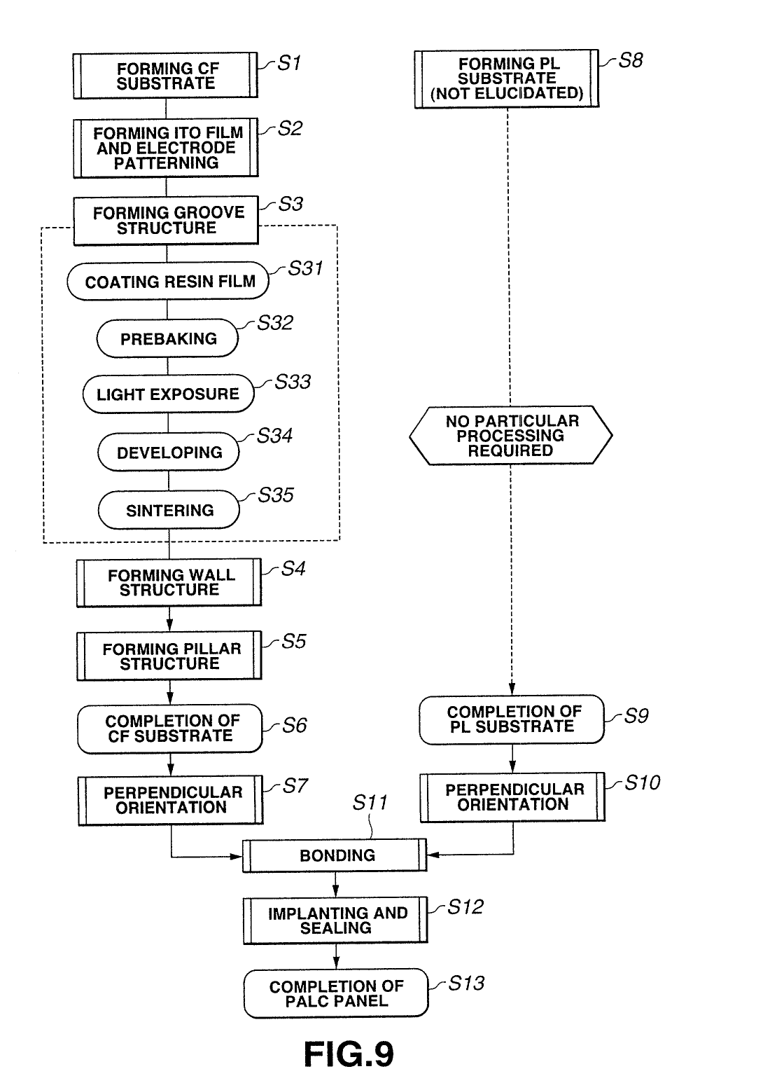

FIG. 9 shows a flowchart illustrating the manufacturing method of the plasma addressed liquid crystal display device according to the present invention. At step S1, the basic structure of a CF substrate is formed. Specifically, a color filter is formed on one surface of the substrate formed e.g., of glass to form a CF substrate. At step S2, a transparent electrically conductive film of, for example, ITO, is formed and patterned to a pre-set shape by photolithography and etching to form a signal electrode. At the next step S3, a groove structure is formed. Specifically, a resin film is applied at step S3, and pre-baking, light exposure, development and sintering are carried out at steps S32, S33, S34 and S35, respectively. That is, a dielectric material, such as acrylic resin, is patterned by photolithographic processing on the signal electrode surface of the CF substrate to form grooves on the diagonal lines. As a principle, there is imposed no limitation on the groove depth (resin thickness). However, if the lowering of the pixel transmittance due to resin transmittance and rise in black luminance by light transmission from the groove wall surface in the absence of applied voltage are taken into consideration, the groove depth is preferably 2 μm or less. From the same reason, the angle of inclination of the groove wall surface is desirably 45° or less. On the so-formed groove structure, a wall structure axially symmetrically controlling the orientation of liquid crystal molecules is formed at step S4. Specifically, this wall structure is formed by patterning the dielectric material, such as black or transparent acrylic resin, by e.g., photolithographic processing and etching. Basically, there is no limitation to the wall height (resin thickness). However, if the lowering of the pixel transmittance due to resin transmittance, rise in black luminance by light transmission from the groove wall surface in the absence of applied voltage and the shortened time involved in the liquid crystal implanting process, the height of the wall structure is 2 μm or less or not larger than one-half the substrate interval or the cell gap d. Also, the inclination of the wall surface of the wall structure is desirably set to 45° or less. Meanwhile, the cell gap needs to be optimized by the optical properties of the liquid crystal material used. Then, at step S5, a spacer (a pillar structure) is formed for prescribing a cell gap in an upper portion of the wall structure. The spacer is formed in an area other than the display pixel area. Similarly to the groove structure and the wall structure, the pillar structure is similarly formed by patterning by processing the dielectric material, such as acrylic resin, with photolithographic processing and etching. The height of the spacer in general may be set in meeting with the cell gap d calculated from an optimum value of the retardation (d·ΔAn) in accordance with refractive index anisotropy Δn of the liquid crystal material. In the present embodiment, the spacer height is determined so as to give a cell gap equal to 6 μm. In order to prevent light leakage due to elimination of light polarization on the spacer wall surface, preferably the dielectric material (insulator) is formed of a black-colored material or a spacer is formed on the black mask. The above process completes the CF substrate (step S6).

In parallel with the preparation of the CF substrate, a PL substrate is formed at step S8. The processing particularly peculiar to the present invention is not required, so that the PL substrate is completed at step S9. The surface of the completed CF substrate is processed with perpendicular orientation (step S7), whilst the PL substrate also is processed with perpendicular orientation processing (step S7). In general, perpendicular orientation processing is performed by coating the substrate surface with a material comprised e.g., of a polyimide resin afforded with perpendicular orientation properties. The two substrates following orientation processing are bonded together at step S11 with the orientation processed surfaces facing inwards. At step S12, a liquid crystal material is sealed in a gap between the two substrates. As the sealing method, the inside of the cell gap is evacuated and the liquid crystal material is sealed via an injection opening. The injection opening then is sealed off. Alternatively, a liquid crystal material is coated on one or both of the substrates prior to bonding and the liquid crystal material is sealed at the same time as bonding. With the ASM liquid crystal, in which the wall structure and the groove structure are formed in the individual orientation areas, orientation setting processing (axis manifesting processing) by the photo-polymerizable resin, so far necessary, is now unnecessary. If strong anchoring is required depending on the material or application, a trace amount of the photo-polymerizable resin and the photo-polymerization initiator may be mixed in advance and the photo-polymerizable resin is reacted as the voltage is applied to the gap between the liquid crystals by way of axis manifesting processing. A plasma addressed liquid crystal panel (PALC panel), thus prepared, is sandwiched between a polarization plate and a phase difference film for black angle of field of view correction at the perpendicular nicol position to complete the liquid crystal display device of the PALC system embodying the present invention (step S13).

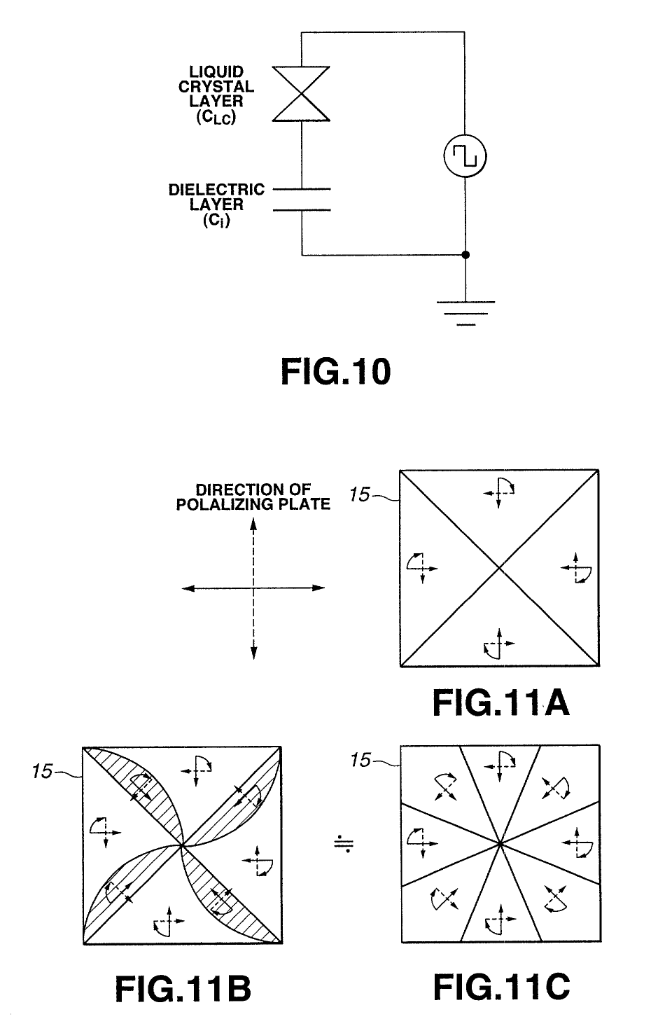

FIG. 10 is an equivalent circuit diagram which has simplified the plasma addressed liquid crystal display device of the present invention to the maximum extent possible. The liquid crystal layer contained in the display cell 1 is represented by a capacitance CLC, whilst a dielectric sheet (dielectric layer) separating the display cell and the plasma cell is represented by a capacitance Ci. Across both ends of serially connected CLC and Ci, there are applied picture signals. The driving voltage actually applied to the liquid crystal layer is obtained on capacitance division.

FIG. 11 shows a modeled axial symmetrical orientation of the plasma addressed liquid crystal display device. In FIG. 11, solid line arrows indicate the direction of orientation on the side of the structure forming substrata, whilst broken line arrows indicate the direction of orientation on the side of the facing substrate. Also, arcuate arrows indicate the direction of distortion of molecular orientation. On the other hand, double-headed solid-line arrows indicate the direction of the polarization plate on the side of the structure forming substrate, whilst double-headed broken-line arrows indicate the direction of the polarization plate on the facing substrate, hereinafter the same. FIG. 11A indicates axial symmetrical orientation of the liquid crystal display device according to the present invention. The orientation area 15 is divided into four segments by diagonal lines to give four-domain orientation. FIG. 11B shows axial symmetrical orientation of the plasma addressed liquid crystal display device shown in FIG. 3. The orientation shown is the axial symmetrical orientation exhibiting the Schlieren pattern or an arrow wheel pattern. FIG. 11C shows a modeled representation of actual orientation shown in FIG. 11B. The orientation shown in FIG. 11C may be deemed to be approximately 8-domain orientation.

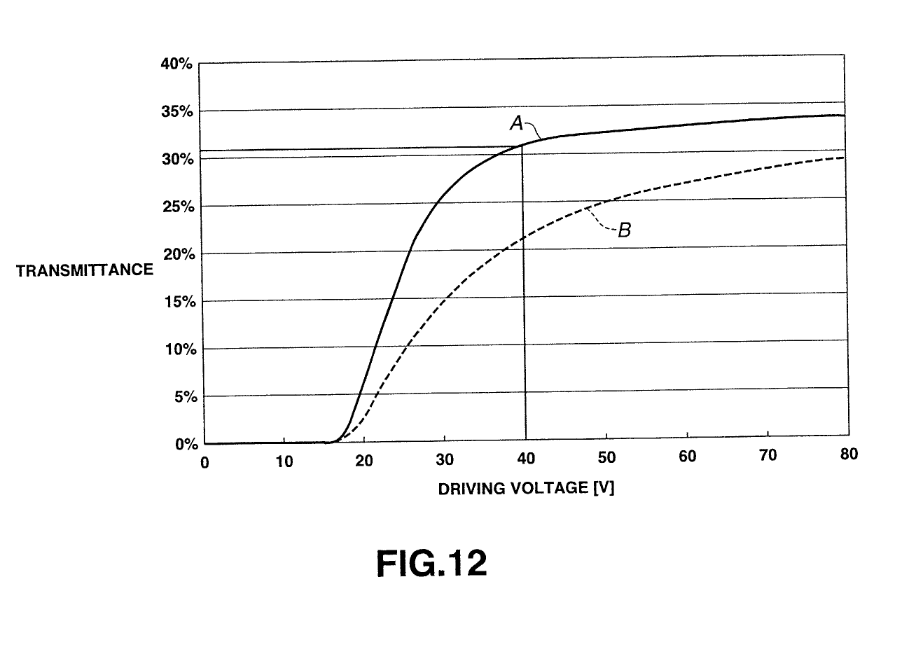

FIG. 12 shows results of simulation of transmittance/driving voltage characteristics of the plasma addressed liquid crystal display device. Specifically, curves A and B denote results of simulation of 4-domain orientation and 8-domain orientation, respectively. As may be seen from the graph of FIG. 12, steepness of the driving voltage/transmittance characteristics is improved appreciably with the orientation system combining the wall structure with the groove structure thus realizing high transmittance with a lower driving voltage.

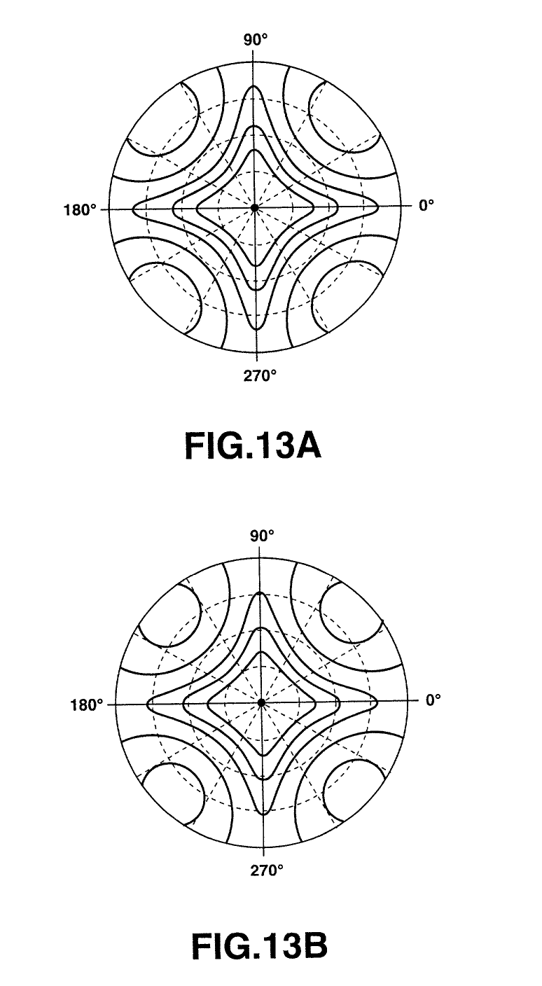

FIGS. 13A, 13B show results of simulation of angle of view characteristics for 4-domain orientation and 8-domain orientation, respectively. In these graphs, the abscissa and the ordinate indicate the left-and-right direction and the up-and-down direction of the screen, respectively. These figures also show the angle of view direction with respect to the substrate. The curves shown in these graphs are curves of equal contrast, with the graphs indicating the angle of view direction for which equal contrast is desired. As may be seen from comparison of FIGS. 13A and 13B, the 4-domain orientation is of an angle of view in the up-and-down and left-and-right directions of the screen slightly broader for the 4-domain orientation than for the 8-domain orientation.

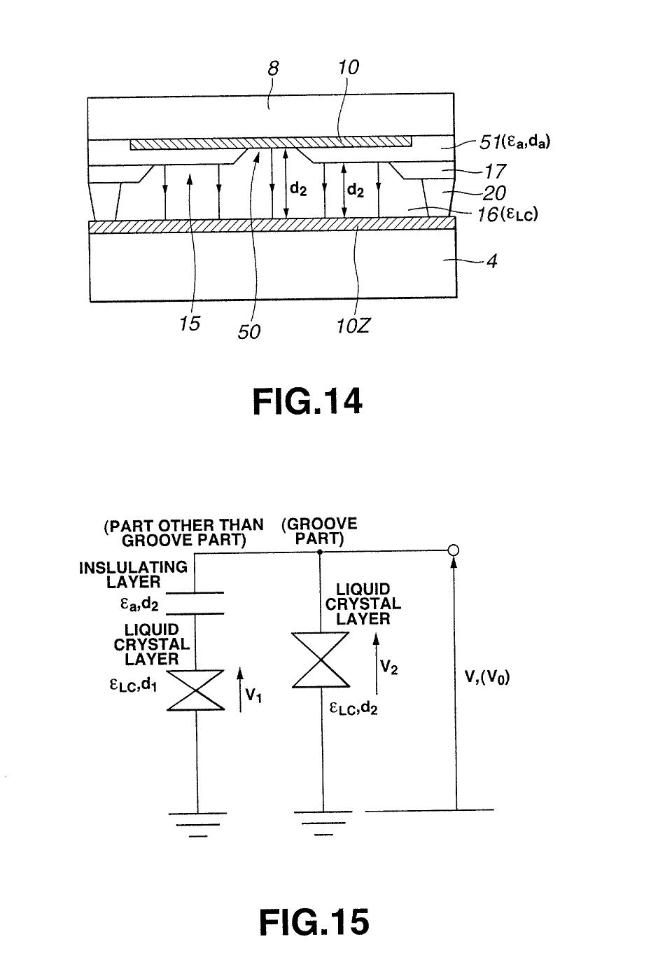

The dimension in depth of the groove structure, significantly influencing the display performance, is now explained. FIG. 14 shows a modeled representation of the liquid crystal display device of the simplified structure shown in FIG. 2. The specific inductive capacity and the thickness of the insulating film 51, carrying the groove 50, are indicated εa and da, respectively. Therefore, the groove depth is approximately equal to da. The dimension between the electrodes 10 and 10Z, facing each other, is indicated d2. The thickness of the portion of the area 15 defined by the wall section 17 and not carrying the groove is indicated display cell 1 is indicated display cell 1. In addition, the specific inductive capacity of the liquid crystal 16 is indicated εLC. Since electrical voltage is applied to the majority of the area 15 through the insulating film 51, carrying the groove 50, voltage drop by the capacitance corresponding to the groove depth is produced. The amount of the voltage drop is increased proportionate to the groove depth.

FIG. 15 is an equivalent circuit diagram of a modeled liquid crystal display device. The groove part is formed solely by a liquid crystal layer, with an area other than the groove part being represented by a series connection of the insulating film 51 and the liquid crystal layer 16. The voltage applied across the paired electrodes 10, 10Z is denoted V, the effective voltage applied to the liquid crystal layer of the groove part is denoted V2 and the effective voltage applied to the liquid crystal layer other than the groove part is denoted V1. It is noted that V0 denotes the driving voltage applied when the groove depth is 0. In other words, V0 denotes the driving voltage when the groove structure is not formed and only the wall structure is formed.

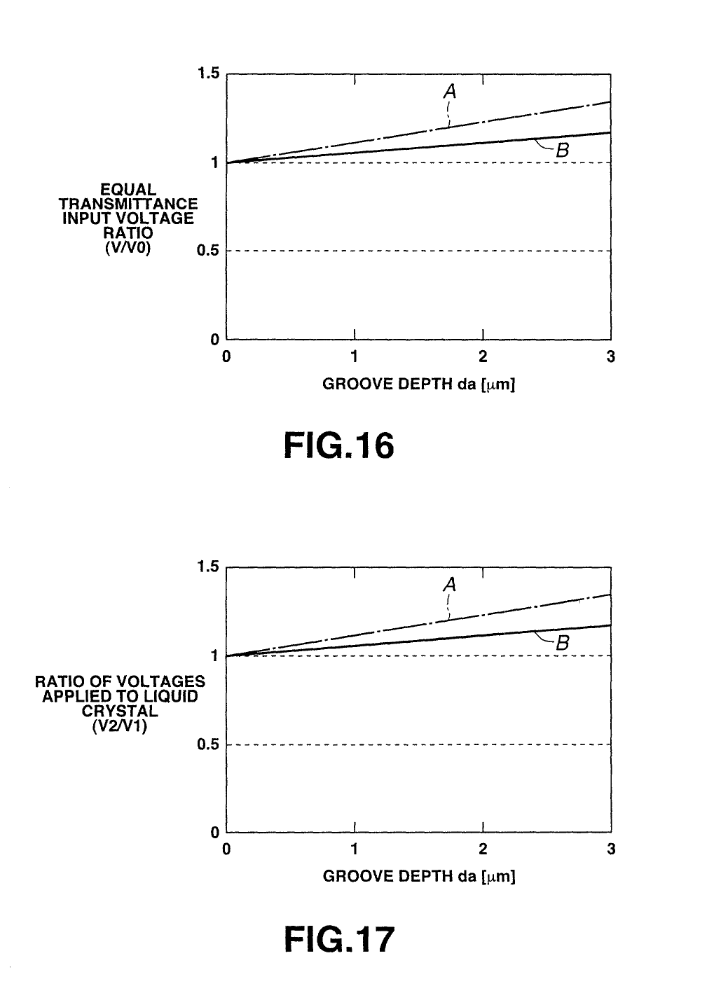

FIG. 16 shows the results of simulation employing the model shown in FIGS. 14 and 15. In FIG. 16, the ordinate and the abscissa denote equal transmittance input voltage ratio (V/V0) and the groove depth da, respectively, whilst straight lines A and B denote cases with the specific inductive capacity εa of the insulating film 51 equal to 5 and 10, respectively. The driving voltage required in realizing a pre-set transmittance in case there is formed no groove is indicated V0. The driving voltage necessary to acquire the same transmittance when the groove part is formed is indicated by V0. As may be seen from the graph, the driving voltage V for acquiring the same transmittance is increased in proportion to the groove depth. So, the depth of the groove da as small as possible is meritorious in view of power consumption.

FIG. 17 shows the results of simulation by taking the ratio of the voltage applied to the liquid crystal part (V2/V1) and the groove depth da on the ordinate and on the abscissa, respectively. As aforesaid, V1 and V2 denote the voltage applied to the portion of the liquid crystal layer other than the groove part and the voltage applied to the liquid crystal layer of the groove part, respectively. As may be seen from the graph, the larger the groove depth da, the larger becomes the ratio of V2 to V1. Since the voltage can be applied easily by the presence of the groove part, and the inclined groove surface is increased with increasing depth of the groove part, the orientation controlling force is increased. So, from the viewpoint of the orientation controlling force for realizing the axially symmetrical orientation, a larger value of the groove depth da is meritorious. From the above results of simulation, the groove depth of 0.5 to 2 μm is desirable for the size setting of the cell gap on the order of 6 μm. However, the voltage drop by the insulating film 51 can be adjusted by the specific inductive capacity μa. As may be apparent from comparison of the straight lines A and B, the power consumption may be lowered by increasing the specific inductive capacity μa.

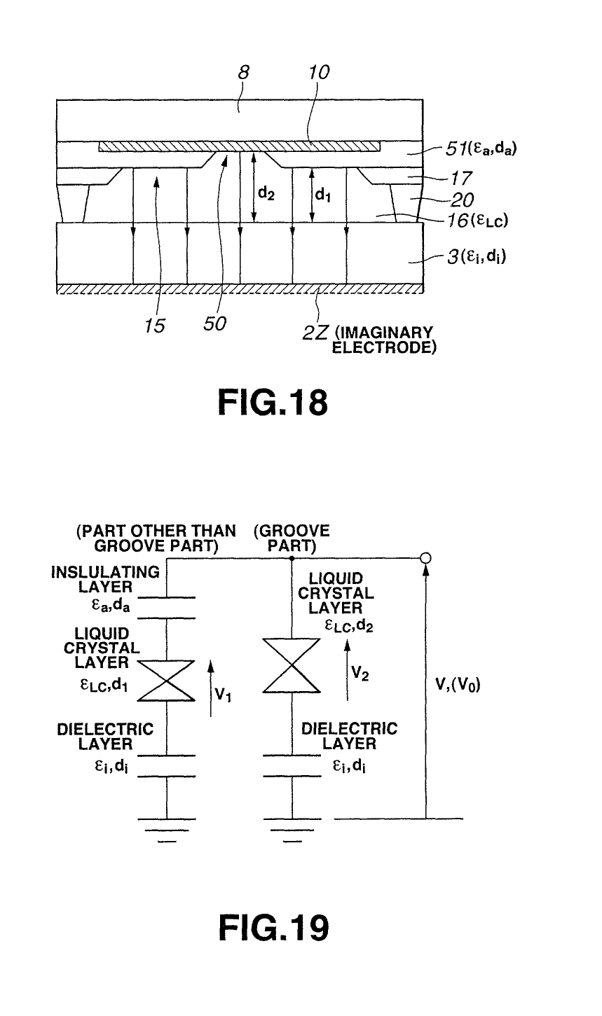

FIG. 18 schematically shows a modeled liquid crystal display device of the plasma addressing type shown in FIG. 8. As may be apparent from comparison to FIG. 14 showing a simple matrix type model, an imaginary electrode 2Z is presented on the reverse surface of the dielectric sheet 3 in the plasma addressed type. This imaginary electrode 2Z is produced by plasma discharge on a plasma cell, not shown. Meanwhile, the specific inductive capacity and the thickness of the dielectric sheet 3 composed e.g., of an ultra-thin dielectric material are denoted by εi and di, respectively.

FIG. 19 is an equivalent circuit diagram of the model shown in FIG. 18. This model differs from the simple matrix type model in that there is added the capacitance of the dielectric layer comprised of the dielectric sheet 3 in addition to that of the groove part and the area other than the groove part. So, in the groove part, the voltage resulting from the dielectric layer and the liquid crystal layer is the voltage V2 applied to the liquid crystal layer, while the voltage resulting from capacitance division by the insulating layer, liquid crystal layer and the dielectric layer is the driving voltage V1 applied to the liquid crystal layer in the area other than the groove part.

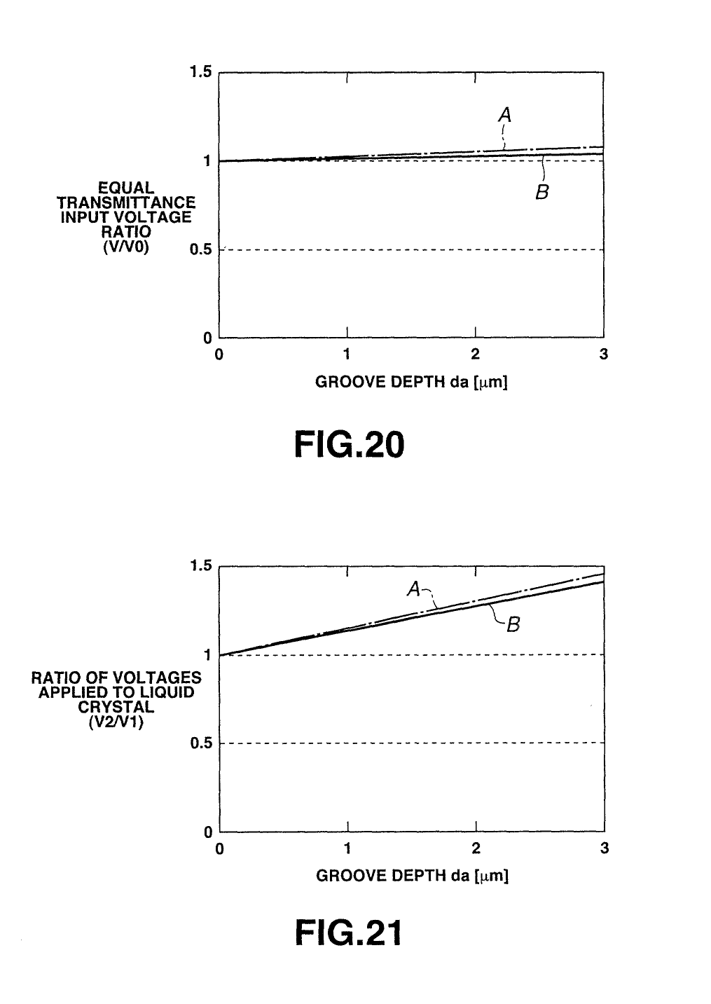

FIG. 20 shows the results of simulation employing the model shown in FIGS. 18 and 19. The equal transmittance input voltage ratio (V/V0) and the groove depth da are plotted on the ordinate and on the abscissa, respectively. As may be apparent from comparison of FIGS. 16 and 20, changes in the input voltage in case the groove depth is increased become smaller by the effect of capacitance division between the liquid crystal layer 16 and the dielectric sheet 3 separating the plasma cell 2 and the display cell, so that the power loss is decreased.

FIG. 21 shows a graph for illustrating groove depth dependency of the voltage ratio applied to the liquid crystal part (V2/V1). In the case of the plasma addressed liquid crystal display device, in which the thickness of the liquid crystal layer is increased in the groove part of the orientation area than that in the orientation area portion other than the groove part, the capacitance is correspondingly lowered so that the voltage applied to the groove part is larger, as shown in the graph of FIG. 21. In particular, as may be seen from comparison of FIGS. 17 and 21, since the voltage applied to the groove part becomes larger, a strong orientation controlling force is produced, thus improving orientation stability. As shown in FIGS. 20 and 21, if the groove structure is applied to the plasma addressed liquid crystal display device, the latitude of material selection is broader because effect variations are small as compared to changes in the specific inductive capacity of the insulating material constituting the grove structure.

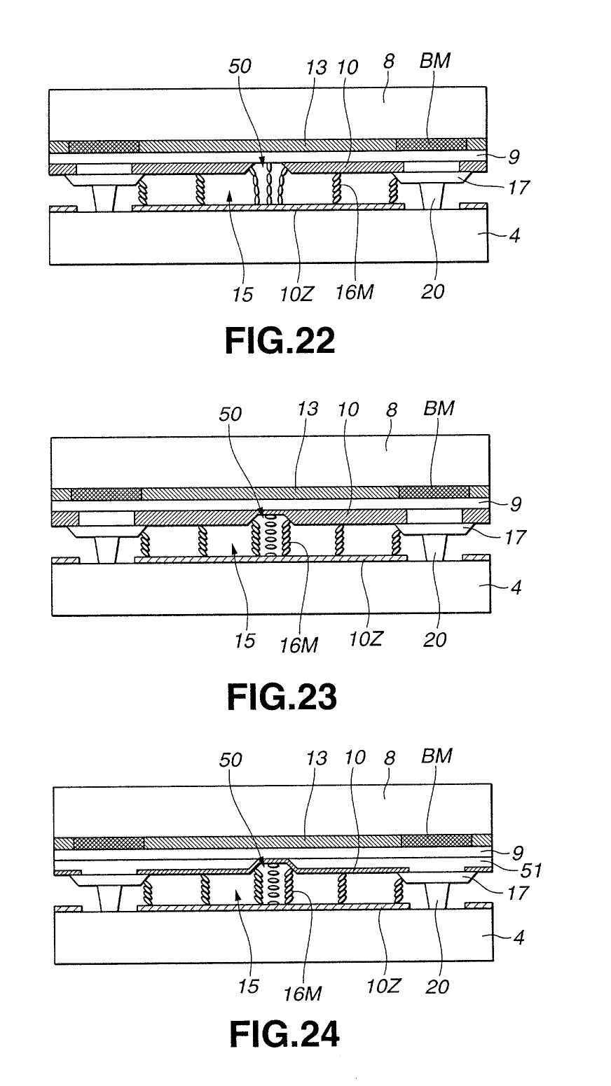

FIG. 22 shows a schematic cross-sectional view of a modification of the simple matrix liquid crystal display device shown in FIG. 2. In the present embodiment, a transparent electrode 10 is provided through the planarizing film 9 below the color filter 13 containing the black matrix BM. This transparent electrode 10 is etched to provide the groove 50. In the present embodiment, in which no additional insulating film is used for forming the groove, the effect in voltage drop may be evaded. Meanwhile, if the electrode is etched directly, no electrical field is applied to the groove 50. However, since the electrical field is spread from the surrounding portion, as shown, there may be realized a stronger groove orientation effect.

FIG. 23 shows a further modification, in which parts corresponding to those of FIG. 22 are indicated by corresponding reference numerals. In the present embodiment, the transparent electrode 10 is of a thicker thickness and the increased thickness portion is partially etched to produce the groove 50. Since the entire surface of the groove 50 is formed of an electrically conductive material, no voltage drop due to interposition of the insulating film is produced, thus eliminating power loss.

FIG. 24 shows a partial cross-sectional view showing another modification. In the present embodiment, an insulating film 51 is provided between the planarizing film 9 and the electrode 10 and is etched to produce the groove 50. Since the groove 50 again is completely coated by the transparent electrode 10, no voltage drop is produced.

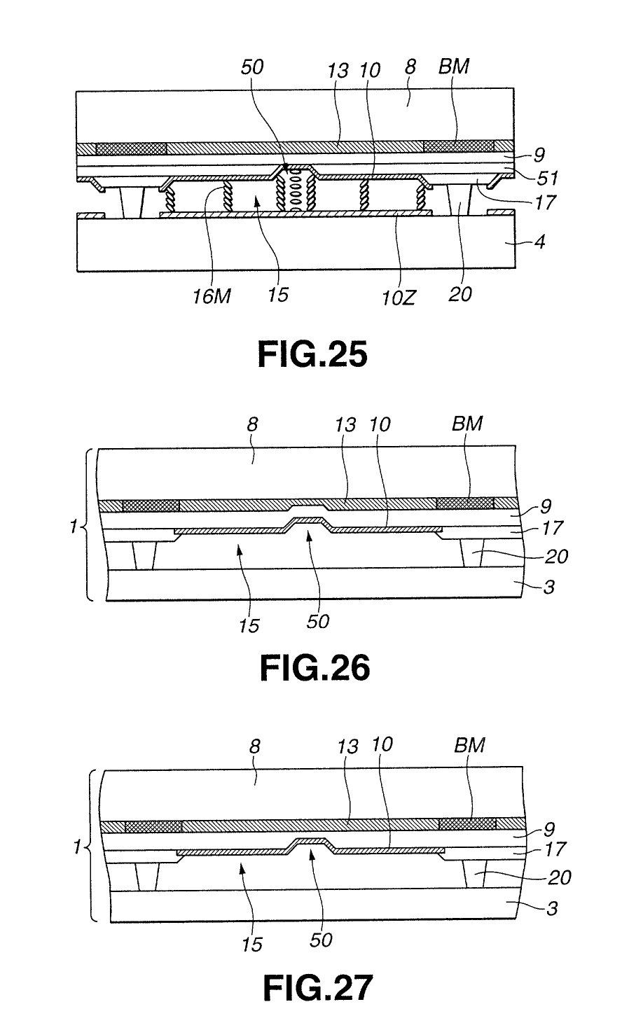

FIG. 25 shows a further modification. This modification differs from FIG. 24 in that the electrode 10 is extended not only on the inclines surface of the groove but also on the inclined surface of the wall section 17 to remove voltage drop by the sidewall section of the wall section 17.

FIG. 26 is a schematic partial cross-sectional view showing a modification of the plasma addressed liquid crystal display device shown in FIG. 8 and particularly showing only a portion of the display cell 1. In the present embodiment, a portion of a colored resin film of the color filter 13 is partially etched to produce the groove 50.

FIG. 27 shows a further modification in which the planarizing film 9 interposed between the color filter 13 and the electrode 10 is selectively etched to produce the groove 50.

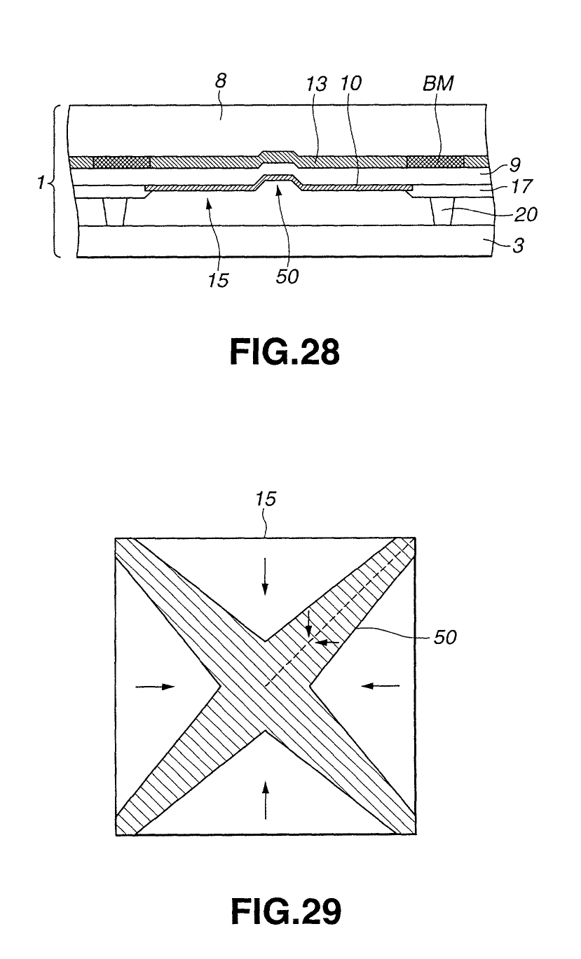

FIG. 28 shows a further modification in which the inner surface of the substrate 8 of e.g., a glass plate is partially etched to produce the groove 50.

FIG. 29 is a plan view showing a modification of the groove structure shown in FIG. 2c. Within the rectangular orientation area 15, there is formed a groove 50 extending along each diagonal line. This groove 50 is increased in groove width from the periphery towards the center of the rectangular area 15. By this configuration, the orientation controlling force in the arrow direction is increased in the inside of the groove 50, as shown shaded, thus allowing to suppress disturbances.

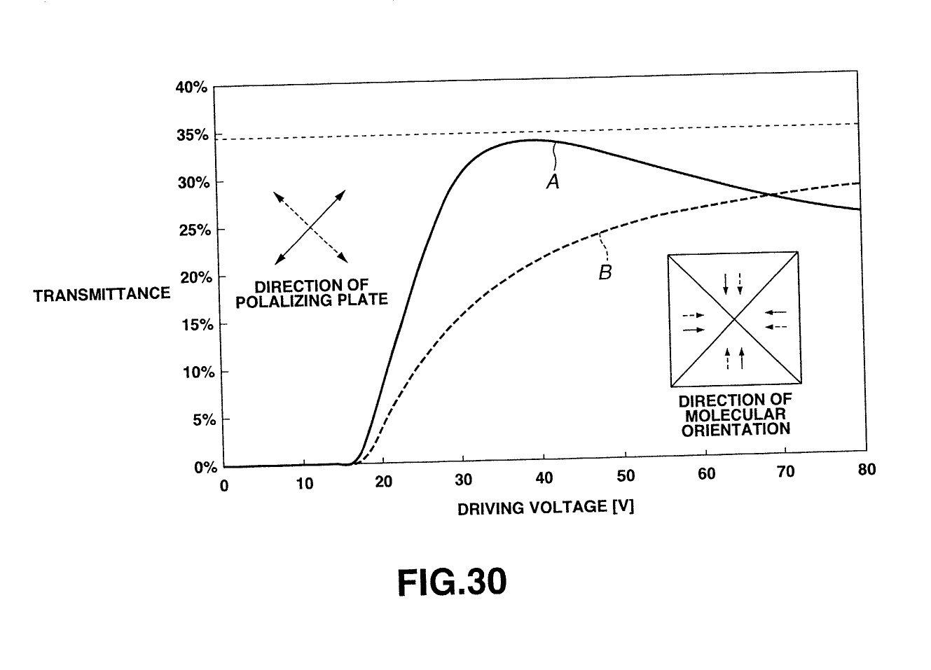

In the above-described embodiments, the TN mode is unexceptionally used, such that orientation is such as to distort the direction of orientation of liquid crystal molecules by e.g., 90° between the cell gaps. Usually, distorted orientation is realized by the rubbing directions of the upper and lower substrate surfaces extending at right angles to each other. However, in the ASM mode employing the n-type nematic liquid crystal, a chiral substance is added to the liquid crystal so as to produce 90° distorted orientation on voltage application. The amount of distortion is determined by the liquid crystal material and the chiral substance used and by the concentration of addition thereof. The optical performance in the TN mode depends on the optical rotatory performance occurring along the orientation of liquid crystal molecules. The electrically controlled birefringence (ECB) mode may also be used in place of the TN mode. In the ECB mode, no chiral substance is added to the liquid crystal such that the liquid crystal molecules are oriented without distortion on voltage application. This is termed homogeneous orientation. The optical performance is based on the birefringent effect of the liquid crystal molecules. So, the polarization plate needs to be inclined at 45° relative to the orientation of molecules by cross-nicol orientation. The graph of FIG. 30 corresponds to that of FIG. 12 which uses the TN mode. As in FIG. 12B, curves A and B in FIG. 30 denote the transmittance/driving voltage characteristics of the 4-domain orientation with addition of the groove structure and the 8-domain orientation which uses the TN mode without addition of the groove structure, that is the results of simulation of characteristics of the ASM of the prior art, respectively. As may be seen from the graph, the transmittance/driving voltage characteristics can be steep by addition of the groove structure to the wall structure even in the ECB mode. Moreover, as may be seen from comparison of the curve A of FIG. 12 and the curve A of FIG. 30, steepness of the transmittance/driving voltage may be more outstanding with the ECB mode than that with the TN mode.

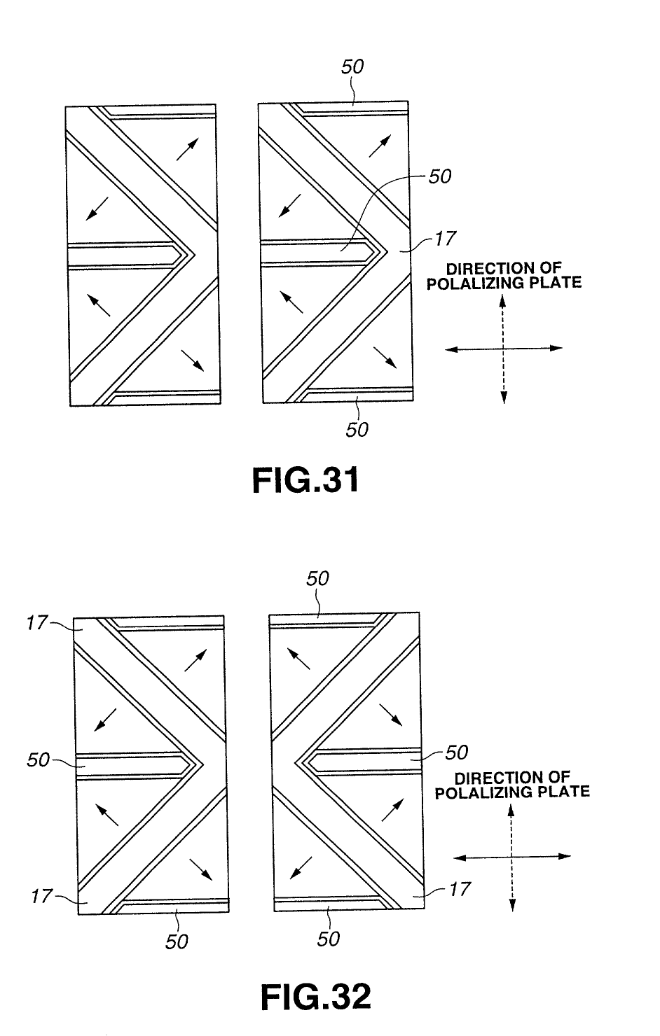

FIG. 31 schematically shows a modification of the combination of the wall structure pattern and the groove structure pattern. In the present modification, the wall section 17 is formed obliquely in the area of orientation, whereas the groove structure 50 is formed transversely therein. By this combination of the wall section 17 and the groove structure 50, liquid crystal molecules are oriented obliquely, as indicated by arrows. This orientation system is appropriate for the ECB mode. That is, in the ECB mode, a pair of polarization plates arranged in a cross-nicol orientation need to be bonded from above and below on the liquid crystal panel. At this time, the axes of polarization of the respective polarization plates need to be at an angle of 45° relative to the direction of orientation of the liquid crystal. Thus, if the orientation control of FIG. 31 is used, the axes of polarization of the polarization plates run parallel to the left-and-right direction and to the up-and-down direction of the screen. Since in general the angle of view characteristics in case of normally black display are favorable in the direction of the axis of polarization, it is possible to realize angle of view characteristics similar to those of the angle of view characteristics of the TN mode shown in FIG. 13.

FIG. 32 shows a modification of the embodiment shown in FIG. 31. In the present modification, the wall section 17 is parallel to the diagonal direction of the rectangular area, whilst the groove area 50 is formed parallel to the side of the rectangular area. The liquid crystal molecules are oriented obliquely, as in FIG. 31.

What is claimed is:

1. A liquid crystal display device comprising:
a pair of substrates arranged facing each other with a pre-set gap in-between;
liquid crystals held in said gap;
means for applying an electrical field to said liquid crystals to change the state of orientation thereof;
a wall structure formed in each of small-sized areas obtained on sub-division along at least one substrate for orienting the liquid crystals lying in each small-sized area axially symmetrically on application of said electrical field; and
a groove structure formed in each of said small-sized areas and adapted for adjusting the axial symmetrical orientation of said liquid crystals in cooperation with said wall structure.

2. The liquid crystal display device according to claim 1 wherein said wall structure is formed for encircling a rectangular area and
wherein said groove structure is formed for extending along diagonal lines of said rectangular area.

3. The liquid crystal display device according to claim 2 wherein the liquid crystals in each small-sized area are divided into four groups and are oriented symmetrically with respect to an axis perpendicular to a point of intersection of said two diagonals lines.

4. The liquid crystal display device according to claim 1 wherein said one substrate is a transparent plate and a color filter layer, a transparent insulating layer and a transparent electrically conductive layer are formed on one surface thereof;
said groove structure being formed by patterning at least one of said color filter layer, transparent insulating layer and the transparent electrically conductive layer.

5. The liquid crystal display device according to claim 1 wherein said one substrate includes an electrode as means for applying an electronic field to said one substrate; and
wherein said groove structure is formed in an insulating layer formed in said electrode itself or in an insulating film arranged on a reverse surface or a front surface of said electrode.

6. The liquid crystal display device according to claim 1 wherein said liquid crystals are of negative dielectric constant anisotropy and
wherein the surfaces of said two substrates are processed for orientation for orienting said liquid crystals perpendicularly in the absence of applied voltage.

7. The liquid crystal display device according to claim 1 wherein a photo-polymerizable resin is added to said liquid crystals for stabilizing the state of axially symmetrical orientation produced on application of an electrical field.

8. The liquid crystal display device according to claim 1 wherein the axially symmetrical orientation of said liquid crystals is distorted along said axis and display is by exploiting optical rotating characteristics.

9. The liquid crystal display device according to claim 8 wherein a chiral substance is added to said liquid crystals for distorting the state of orientation thereof.

10. The liquid crystal display device according to claim 1 wherein the axially symmetrical orientation of said liquid crystals is not distorted along said axis and display is by exploiting birefringence.

11. The liquid crystal display device according to claim 1 wherein said means for applying the electrical field is made up of signal electrodes formed in columns on one substrate and discharge channels formed in rows in the other substrate, said discharge channel being separated from said liquid crystals by a dielectric sheet.

12. The liquid crystal display device according to claim 1 wherein said means for applying the electrical field is formed on both substrates and is facing electrodes with said liquid crystals in-between.

13. A method for the preparation of a liquid crystal display device comprising a pair of substrates arranged facing each other with a pre-set gap in-between;
liquid crystals held in said gap;
means for applying an electrical field to said liquid crystals to change the state of orientation thereof, said method comprising the steps of
forming a wall structure in each of small-sized areas obtained on sub-division along at least one substrate for orienting the liquid crystals lying in each small-sized area axially symmetrically on application of said electrical field; and
forming a groove structure formed in each of said small-sized areas and adapted for adjusting the axial symmetrical orientation of said liquid crystals in cooperation with said wall structure.
